(19) United States
(12) Patent Application Publication
(10) Pub. No.: US 2005/0030464 A1
(43) Pub. Date: Feb. 10, 2005

(54) LCD display of slim frame structure

(75) Inventor: Chiung-Pin Wang, Chang Hua Hsien (TW)

Correspondence Address: BRUCE H. TROXELL, SUITE 1404, 5205 LEESBURG PIKE, FALLS CHURCH, VA, 22041, US

(73) Assignee: AU Optronics Corp.

(21) Appl. No.: 10/787,213

(22) Filed: Feb. 27, 2004

(30) Foreign Application Priority Data
Aug. 6, 2003 (TW) 92121532

(51) Int. Cl. G02F 1/1345

(52) U.S. Cl. 349/149

(57) ABSTRACT

An LCD display comprises a glass substrate, a plurality of first conductive lines, a dielectric layer, and a plurality of second conductive lines. An upper surface of the glass substrate can be divided into a display region and a surrounding frame region. The pixel devices are located at the display region, and each of the pixel devices comprises a thin film transistor (TFT) utilized as a switch. The first conductive lines are located at the frame region to control on and off of part of the TFTs, the dielectric layer is also formed at the frame region for covering the first conductive lines, and the second conductive lines are formed on the dielectric layer to control on and off of the rest of the TFTs.

### BACKGROUND OF THE INVENTION

(1) Field of the Invention

This invention relates to an LCD (Liquid crystal display) panel, and more particularly to an LCD panel having a slim frame structure for increasing a visible range thereof.

(2) Description of the Prior Art

A LCD can be functioned by driving liquid crystal molecules to change the transparency of liquid crystal layer. In order to change the direction of liquid crystal molecules, a pair of electrodes is formed on both sides of the liquid crystal layer. The lower electrode is a metal electrode characterized in low work function and is utilized as an electron-ejecting layer, while the upper electrode is, a transparent electrode utilized as an electron-receiving layer. In the art, the metal electrode, which may be formed of Li, Mg, Ca, Al, Ag, In, or any alloy the like, usually has a thickness of 100˜400 nm, and, on the other hand, the transparent electrode is usually formed of ITO (Indium tin oxide).

Referring to FIG. 1, an LCD 1 comprises a CF (Color filter) panel 10, a TFT (Thin film transistor) panel 30, and an interposed liquid crystal layer 20. A TFT matrix including a predetermined array of TFTs is formed on an upper surface of the TFT panel 30, and each TFT thereof connects to a pixel electrode. By biasing the pixel electrode with respect to a common electrode formed on a lower surface of the CF panel 10, liquid crystal molecules of the liquid crystal layer 20 can then be driven to display a predetermined image.

Referring to FIG. 2A, which shows a top view of a traditional TFT panel 30, the upper surface of the TFT panel 30 includes a rectangular displaying area 310 and a surrounding frame area 320. FIG. 2B is an enlarged top view reference to D of FIG. 2A, and FIG. 2C is a cross-section view reference to line a-a′ of FIG. 2B. As shown, the TFT matrix is formed atop the displaying area 310 in which each row of the TFTs 330 connects to a respective gate line 340 and each column of the TFTs 330 connects to a respective signal line 350. A drain electrode of each TFT 330 of the TFT matrix connects to a pixel electrode 60. In addition, a plurality of metal lines 322 is formed atop the frame area 320, and each metal line 322 connects to a respective gate line 340, and thereby a driving circuit 360 is able to control a scanning sequence of the gate lines 340 through the metal lines 322.

In general, for simplifying the fabrication process, the TFT 330 gate electrodes, the gate lines 340, and the metal lines 322 are formed in a metal layer. However, restricted by the resolution of lithographic processes and the cleanness of the fabrication environment, a predetermined interval between neighboring metal lines 322 is preserved so as to prevent possible short-circuiting. Therefore, the frame area 320 for locating such metal lines 322 restricts the enlargement of the displaying area 310.

Accordingly, the present invention is directed to a liquid crystal panel having a slim frame structure that can provide an enlarged displaying area 310 to the panel.

### SUMMARY OF THE INVENTION

A primary object of the present invention is to provide a new LCD display which slims a liquid crystal panel by decreasing the width of the frame area.

In order to achieve the above object, the liquid crystal panel in accordance with the present invention comprises a glass substrate, a plurality of first conductive lines, a dielectric layer, and a plurality of second conductive lines. An upper surface of the glass substrate includes a displaying area and a surrounding frame area. A plurality of pixels is positioned on the displaying area in a manner of matrix, and each pixel is controlled by a TFT.

The first conductive lines formed atop the frame area and covered by the dielectric layer are used to switch part of the TFTs. The second conductive lines are then formed atop the dielectric layer for switching the rest of the TFTs.

Reference will now be made in detail to the preferred embodiments of the present invention, examples of which are illustrated in the accompanying drawings. Wherever possible, the same reference numbers will be used throughout the drawings to refer to the same or like parts.

### BRIEF DESCRIPTION OF THE DRAWINGS

The present invention will now be specified with reference to its preferred embodiment illustrated in the drawings, in which

FIG. 1 is a schematic cross-section view of a typical liquid crystal display in the art;

FIG. 2A is a schematic top view of a traditional TFT panel of FIG. 1;

FIG. 2B is an enlarged view of a portion D of FIG. 2A;

FIG. 2C is a cross-section view reference to line a-a′ of FIG. 2B;

FIG. 3A is a schematic top view of a preferred TFT panel in the present invention;

FIG. 3B is an enlarged view of a portion E of FIG. 3A;

FIG. 3C is a cross-section view reference to line b-b′ of FIG. 3B;

FIG. 3D is a cross-section view reference to line c-c′ of FIG. 3B; and

FIGS. 4A to 4D are top views showing a preferred manufacturing process according to the present invention.

### DESCRIPTION OF THE PREFERRED EMBODIMENT

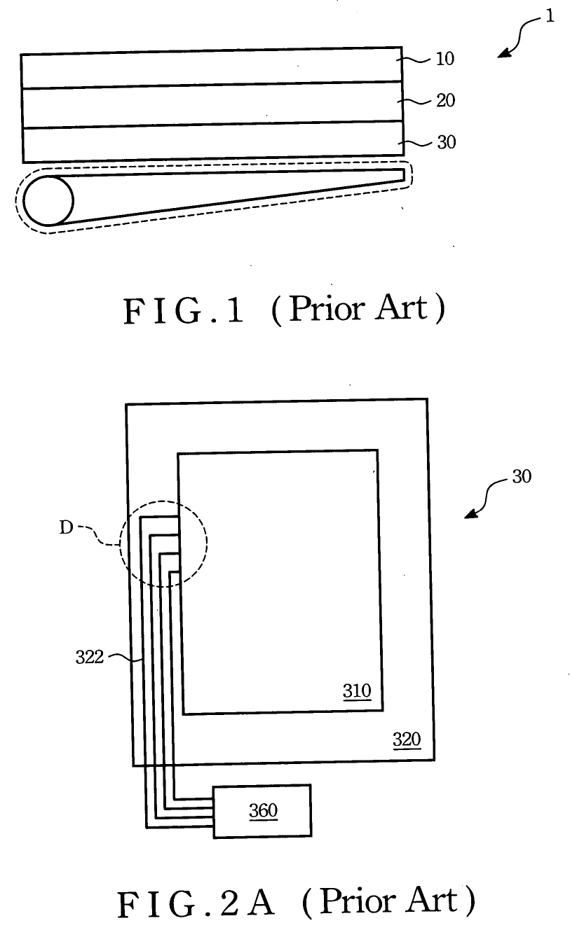

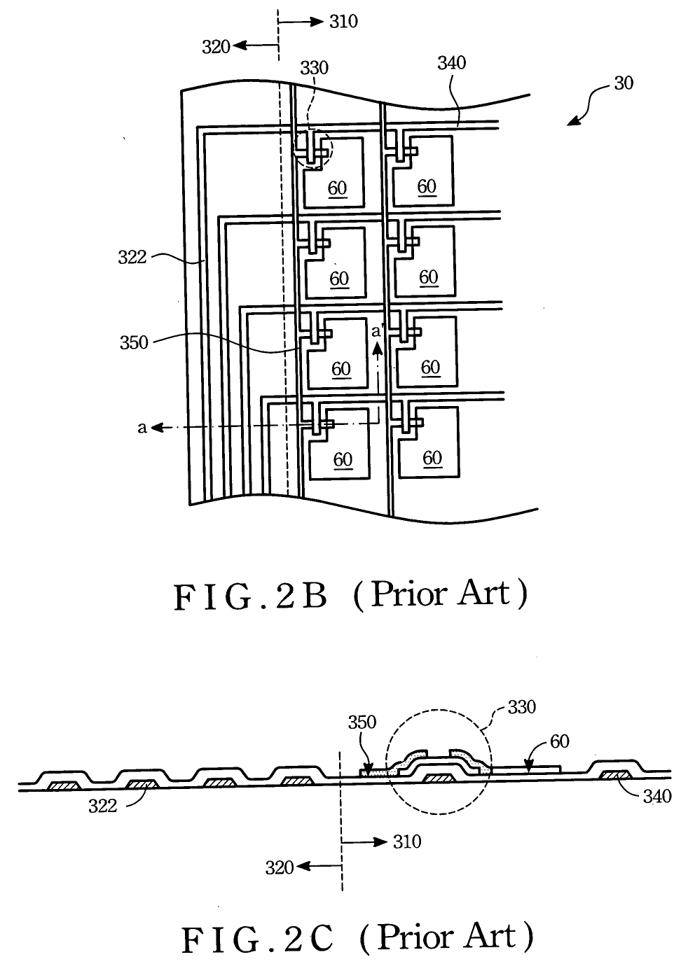

Similar to the traditional design described in FIG. 1, the liquid crystal panel 1 in accordance with the present invention comprises a CF panel 10, a TFT panel 30, and an interposed liquid crystal layer 20. A TFT matrix is formed on an upper surface of the TFT panel 30, in which each TFT thereof connects to a pixel electrode reference to a common electrode formed on a lower surface of the CF panel 10. By biasing the pixel electrode with respect to the common electrode, liquid crystal molecules of the liquid crystal layer 30 can then be driven to display a predetermined image.

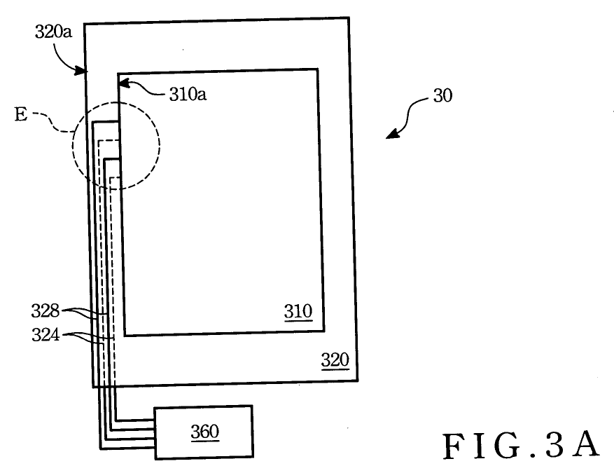

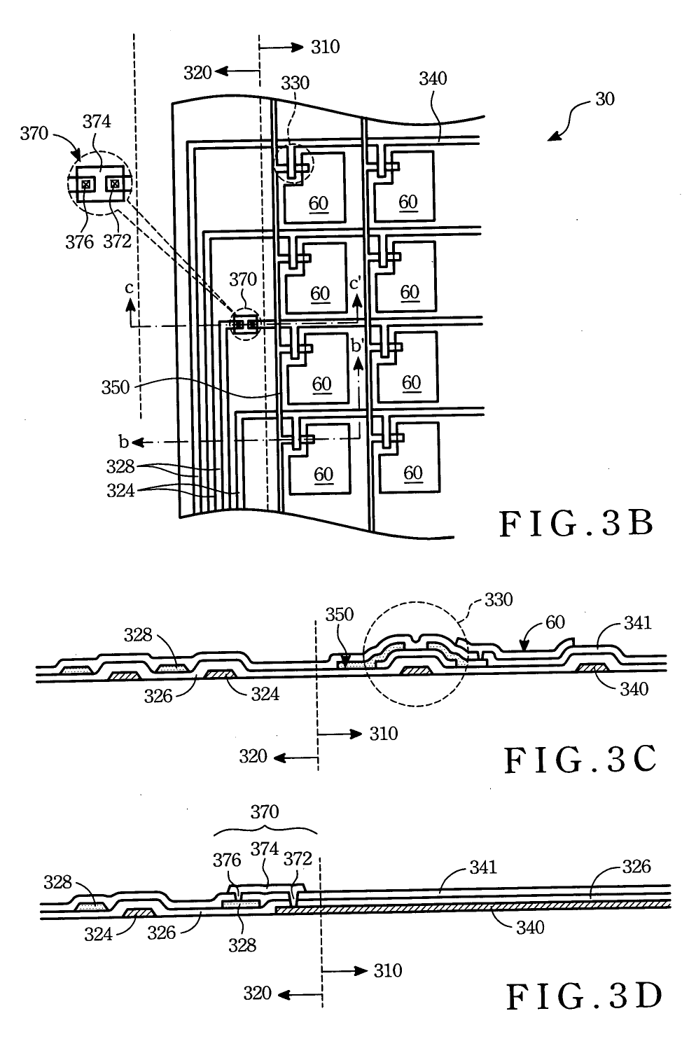

Referring to FIG. 3A, an upper surface of the TFT panel 30 of the present invention includes a rectangular displaying area 310 and a frame area 320. The displaying area 310 is positioned at the center of the TFT panel 30, and the frame area 320 is surrounding the displaying area 310. Referring to FIG. 3B, which is reference to a portion “E” of FIG. 3A, a TFT 330 matrix is formed atop the rectangular displaying area 310, in which each TFT 330 row connects to a respective gate line 340 and each TFT 330 column connects to a respective signal line 350. A drain electrode of each TFT 330 of the TFT matrix connects to a respective pixel electrode 60.

Referring to both FIG. 3B and FIG. 3C, wherein FIG. 3C is a cross-section view reference to line b-b′ of FIG. 3B, a plurality of first conductive lines 324 is formed atop the frame area 320 and positioned along a side of the rectangular displaying area 310 with a predetermined interval. A dielectric layer 326 is formed over the frame area 320 to cover the first conductive lines 324. A plurality of second conductive lines 328 is formed atop the dielectric layer 326 and positioned along the side of the rectangular displaying area 310 with a predetermined interval, and a passivation layer 341 is formed over the dielectric layer 326 for covering the second conductive lines 328. The first conductive lines 324 connect to part of the gate lines 340 while the second conductive lines 328 connect to the rest. Thereby, a driving circuit 360 is able to control a scanning sequence of the gate lines 340 through the first conductive lines 324 and second conductive lines 328.

It should be noted that the second conductive lines 328 and the gate lines 340 are formed in different metal layers. Therefore, as shown in FIG. 3D, which is a cross-section view reference to line c-c′ of FIG. 3B, an interposed structure 370 is sandwiched between the second conductive line 328 and the gate line 340. The interposed connecting structure 370 comprises a first plug 372, an interconnecting line 374, and a second plug 376. The first plug 372 penetrates the dielectric layer 326 and the passivation layer 341 and further connects to the gate line 340, and the second plug 376 penetrates the passivation layer 341 before connecting to the second conductive line 328. Also, the interconnecting line 374 formed atop the passivation layer 341 connects to the first plug 372 and the second plug 376 so as to create a conductive path between the gate line 340 and the second conductive line 328. In a preferred embodiment, the interconnecting line 374 and the pixel electrode 60 are formed in the same conductive layer, such as an ITO layer. On the other hand, because the first conductive line 324 and the gate line 340 are formed in the same metal layer, the interposed connecting structure 370 is not needed.

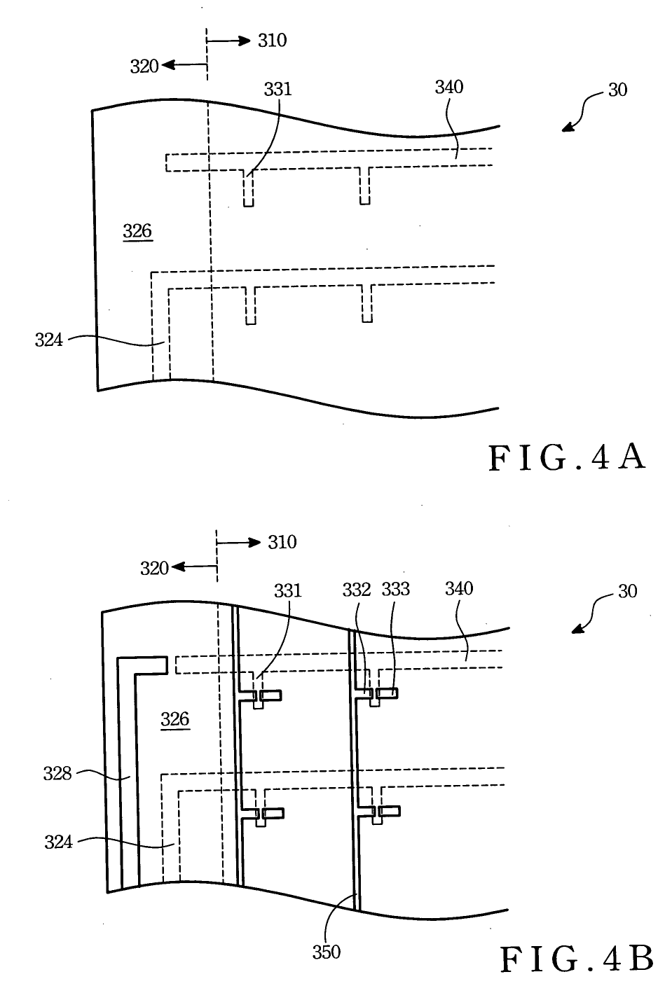

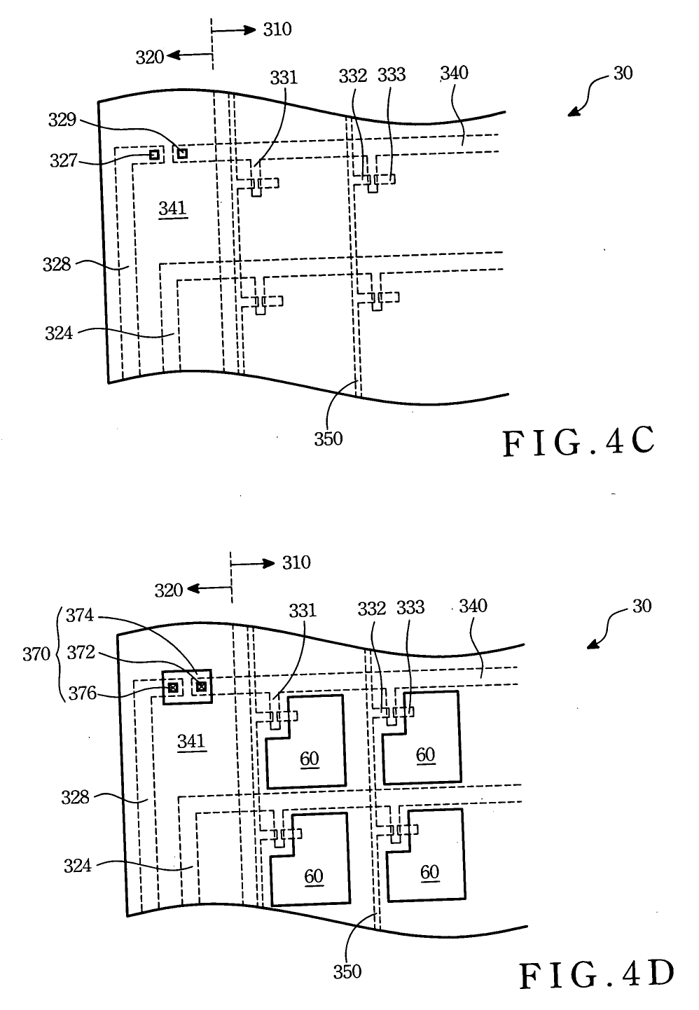

FIG. 4A through FIG. 4D depict a sequence of steps to form a TFT panel 30 in accordance with the present invention. Firstly, a metal layer is formed atop a glass substrate, and then etched to form a plurality of first conductive lines 324, a plurality of gate lines 340 and plural gate electrodes 331 of a TFT matrix, as shown in FIG. 4A. The gate electrodes 331 of each row of the TFT matrix connect to a respective gate line 340, and part of, not all, the gate lines 340 connect to the respective first conductive lines 324. Afterward, a dielectric layer 326 is formed over the glass substrate to cover the first conductive lines 324, the gate lines 340, and the gate electrodes 331. Subsequently, in FIG. 4B, a metal layer is deposited atop the dielectric layer 326, and then etched to form a plurality of second conductive lines 328, a plurality of signal lines 350, and plural source electrodes 332 and drain electrodes 333 of the TFT matrix, and each of the second conductive line 328 is assigned to a gate line 340 which does not have connection with the first conductive lines 324.

Afterward, a passivation layer 341 is formed over the glass substrate to cover the second conductive lines 328, the signal lines 350, and the source electrodes 332 and the drain electrodes 333 of the TFT matrix. The passivation layer 341 is then etched to form openings 327, 329 for exposing the second conductive lines 328 and the respective gate lines 340, as shown in FIG. 4C. Finally, an ITO layer is formed over the passivation layer 341 and thereby filling the openings 327, 329, and is then etched to form a plurality of pixel electrodes 60 and a plurality of connecting structures 370. Each connecting structure 370 utilized to connect the second conductive line 328 and the respective gate line 340 further has a first plug 372, an interconnecting line 374, and a second plug 376.

Compared with the traditional liquid crystal panel described in the background section, the present invention has the following advantages.
(1) In the case that the number of the gate lines 341 is n, then the number of respective metal lines 322 to be placed in the frame area 320 would be n in the traditional design. However, by replacing the metal line 322 with the first conductive lines 324 and the second conductive lines 328 formed in two different metal layers in accordance with the present invention, the number of the first conductive lines 324 demanded would be reduced to n/2, and so is that of the second conductive lines 328. Upon such an arrangement, the width of the frame in accordance with the present invention can be reduced to half the original.
(2) As mentioned above, by decreasing the width of the frame area, the size of the displaying area 310 in accordance with the present invention can be increased as well.

Preferably, both the first conductive lines 324 and the second conductive lines 328 are placed parallel to the boundary of the rectangular displaying area 310, and the dielectric layer 326 interposed is formed of silicon nitride to achieve a better isolation effect. For preventing signal flow in the first conductive lines 324 and the second conductive lines 328 from being disturbed, the interval between the innermost first conductive line 324 and the displaying area 310 boundary is larger than that of the neighboring first conductive lines 324, and the same situation exists at the innermost second conductive line 328. On the other hand, for preventing signal flow in the first conductive lines 324 from being disturbed by the environment noise, the interval between the outermost first conductive line 324 and an outer boundary of the frame area 320 is larger than that of the neighboring first conductive lines 324, and the outermost second conductive line 328 also has the same characteristics.

Referring back to FIG. 3A, it is noted that the first conductive lines 324 and the second conductive lines 328 are placed at the left side of the frame area 320. However, if demanded, the first conductive lines 324 and the second conductive lines 328 can be also placed at any side of the frame area 320. Moreover, the first conductive lines 324 and the second conductive lines 328 are not restricted only to perform scanning sequence to the gate lines 340 as described above. If demanded in another embodiment, the first conductive lines 324 and the second conductive lines 328 of the present invention can be also applied to transfer any signal on the panel 30.

With the example and explanations above, the features and spirits of the invention will be hopefully well described. Those skilled in the art will readily observe that numerous modifications and alterations of the device may be made when retaining the teaching of the invention. Accordingly, the above disclosure should be construed as limited only by the metes and bounds of the appended claims.

1. A flat panel display, comprising:
a glass substrate having an upper surface, which is divided into a displaying area and a surrounding frame area, said displaying area further comprising a plurality of pixel devices, each of said pixel devices comprising a thin film transistor (TFT) utilized as a switch;
a plurality of first conductive lines formed atop said frame area for controlling a portion of said TFTs;
a dielectric layer formed atop said frame area for covering said first conductive lines; and
a plurality of second conductive lines formed atop said dielectric layer for controlling the other said TFTs.

2. The flat panel display of claim 1, wherein said first conductive lines and said gate electrodes of said TFTs are formed in a metal layer.

3. The flat panel display of claim 1, wherein said second conductive lines and source/drain electrodes of said TFTs are formed in a metal layer.

4. The flat panel display of claim 1, wherein said first conductive lines are positioned along a boundary of the displaying area with a predetermined interval.

5. The flat panel display of claim 1, wherein said second conductive lines are positioned along a boundary of the displaying area with a predetermined interval.

6. The flat panel display of claim 1, wherein said dielectric layer is formed of silicon nitride.

7. A method of forming a flat panel display having a plurality of TFTs to control illumination of pixels, comprising the steps of:
forming a plurality of gate lines and a plurality of first conductive lines on a glass substrate, said first conductive lines connecting to part of said gate lines;
forming a dielectric layer on said glass substrate to cover said gate lines and said first conductive lines; and
forming a plurality of sources, drains, and second conductive lines on said dielectric layer, and having said second conductive lines connect to rest of said gate lines.

8. The fabrication method of claim 7, wherein said step of forming said gate lines and said first conductive lines further comprises the steps of:
forming a first metal layer over the glass substrate; and
etching said first metal layer to form said gate lines and said first conductive lines, in which said first conductive lines connect part of said gate lines.

9. The fabrication method of claim 7, wherein said step of forming said second conductive lines further comprises the steps of:
forming a second metal layer over said dielectric layer;
etching said second metal layer to form said sources, said drains, and said second conductive lines;
forming a passivation layer to cover said sources, said drains, and said second conductive lines;
etching said passivation layer to form a plurality of openings to expose said second conductive lines and rest of said gate lines; and
forming a plurality of connecting structures on said passivation layer for filling said openings to connect said second conductive lines and rest of said gate lines.

10. The fabrication method of claim 7, wherein an upper surface of said glass substrate includes a displaying area having said gate lines formed thereon and a surrounding frame area having said first conductive lines and said second conductive lines formed thereon.

11. The fabrication method of claim 7, wherein said first conductive lines are positioned along a boundary of said displaying area with a predetermined interval.

12. The fabrication method of claim 7, wherein said second conductive lines are positioned along a boundary of said displaying area with a predetermined inter-line interval.

13. The fabrication method of claim 7, wherein said dielectric layer is formed of silicon nitride.

14. A liquid crystal display, which is comprised of a color filter layer, a liquid crystal layer, a TFT panel, and a backlight module, the TFT panel comprising:
a rectangular glass substrate having an upper surface, which is divided into a rectangular displaying area positioned at a center of said upper surface and a surrounding frame area, a plurality of pixel devices formed on said display area, each of said pixel devices comprising a thin film transistor (TFT) utilized as a switch;
a plurality of first conductive lines, formed atop said frame area and positioned along a side of said rectangular display area with a predetermined interval, utilized for controlling part of said TFTs, said first conductive lines and gate electrodes of said TFTs formed in a metal layer;
a dielectric layer formed atop said frame area outside said side of said rectangular display area and covering said first conductive lines; and
a plurality of second conductive lines, which is formed atop said dielectric layer and positioned along said side of said rectangular display region with a predetermined interval for controlling rest of said TFTs, said second conductive lines and source/drain electrodes of said TFTs being formed in a metal layer.

15. The liquid crystal display of claim 14, further comprises a driving circuit having connection with gates of said TFTs through said first conductive lines and said second conductive lines.

16. The liquid crystal display of claim 14, wherein said dielectric layer is formed of silicon nitride.
